(19) United States
(12) Patent Application Publication
(10) Pub. No.: US 2005/0213126 A1
(43) Pub. Date: Sep. 29, 2005

(54) Image forming apparatus and image reading apparatus

(75) Inventor: Kunihiro Nakagawa, Shizuoka-ken (JP)

Correspondence Address: FOLEY AND LARDNER;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 11/075,864

(22) Filed: Mar. 10, 2005

(30) Foreign Application Priority Data
Mar. 23, 2004 (JP) 2004-085537

(51) Int. Cl. H04N 1/56; H04N 1/60

(52) U.S. Cl. 358/1.9; 358/504; 358/519

(57) ABSTRACT

An image forming apparatus includes a controller capable of interpreting a plurality of PDLs for describing a plurality of gamma correction patterns and a printer to form images on sheets of paper on the basis of raster image data of gamma correction patterns outputted by the controller. On the sheets of paper, at least two of the images on the basis of the raster image data of the plurality of gamma correction patterns respectively corresponding to the plurality of PDLs are formed.

### CROSS-REFERENCE TO RELATED APPLICATIONS

This application is based upon and claims the benefit of priority from the prior Japanese Patent Application No. 2004-085537, filed on Mar. 23, 2004, the entire contents of which are incorporated herein by reference.

### BACKGROUND OF THE INVENTION

1. Field of the Invention

The present invention relates to an image forming apparatus having a controller capable of interpreting a plurality of PDLs and an image reading apparatus.

2. Description of the Related Art

For example, as indicated in Japanese Patent Application 2002-16803, an image forming apparatus such as a Multi Function Peripheral (MFP) as a printer, a copier, or a composite device stores object information and information described in Page Description Language (PDL) representing its position information.

The PDL is a printer control language for printing characters and graphics using a printer and it is a language which can be interpreted by a computer, Typical PDLs are Post-Script by Adobe Systems, USA and LIPS by Canon.

An image signal inputted externally, on the basis of the aforementioned stored object information and information described in the PDL, is converted to a raster image signal by a controller unit and on the basis of the converted raster image signal, an image is formed on a medium such as paper.

In recent years, image forming apparatuses having a controller unit capable of interpreting a plurality of PDLs have appeared on the market. Raster images converted on the basis of the PDLs are generally different in the gamma characteristics respectively in correspondence with the PDLs. Therefore, an image forming apparatus corresponding to a plurality of PDLs retains several kinds of gamma correction data according to the gamma characteristics of a plurality of PDLs. From data obtained by interpreting gamma correction patterns corresponding to the respective PDLs one by one, printing one by one the gamma correction patterns interpreted one by one, and reading the printed gamma correction patterns one by one again by a scanner, the respective gamma correction data is generated one by one. Further, gamma correction is referred to as conversion of gradated document data converted to a digital signal to data having an optional gradation characteristic.

If the gamma correction processes for the respective PDLs are executed variedly, many sheets of paper are required to output the gamma correction patterns, and the operation is complicated, so that operation errors such as a mistake are increased.

### SUMMARY OF THE INVENTION

The present invention is intended to provide an image forming apparatus having a plurality of PDLs capable of easily making gamma corrections, an image reading apparatus, an image forming method, and an image reading method.

According to the embodiments of the present invention, there is provided an image forming apparatus comprising: a controller capable of interpreting a plurality of PDLs (Page Description Language); a memory unit to store a plurality of gamma correction patterns described in the plurality of PDLs which can be interpreted by the controller; and a printer to form images on sheets of paper on the basis of raster image data of the gamma correction patterns outputted by the controller according to the gamma correction patterns stored in the memory unit, wherein on the sheets of paper, a plurality of images are formed on the basis of the raster image data of the plurality of gamma correction patterns respectively corresponding to the plurality of PDLs.

Further, according to the embodiments of the present invention, there is provided an image reading apparatus comprising: a controller capable of interpreting a plurality of PDLs; a memory unit to store a plurality of gamma correction patterns described in the plurality of PDLs which can be interpreted by the controller; and a scanner to read sheets of paper on which the plurality of gamma correction patterns are formed and output scanner image data, wherein the controller generates a gamma correction table on the basis of position information of the gamma correction patterns obtained by interpreting the plurality of gamma correction patterns described in the plurality of PDLs and the scanner image data.

Furthermore, according to the embodiments of the present invention, there is provided an image forming method comprising: interpreting a plurality of PDLs (Page Description Language) by a controller; storing a plurality of gamma correction patterns described in the plurality of interpreted PDLs; and forming images on sheets of paper on the basis of raster image data of the gamma correction patterns outputted by the controller according to the stored gamma correction patterns, wherein a plurality of images are formed on the sheets of paper on the basis of the raster image data of the plurality of gamma correction patterns respectively corresponding to the plurality of PDLs.

Furthermore, according to the embodiments of the present invention, there is provided an image reading method comprising interpreting a plurality of PDLs by a controller; storing a plurality of gamma correction patterns described in the plurality of interpreted PDLs; and reading sheets of paper on which the plurality of gamma correction patterns are formed and outputting scanner image data, wherein the controller generates a gamma correction table on the basis of position information of the gamma correction patterns obtained by interpreting the plurality of gamma correction patterns described in the plurality of PDLs and the scanner image data.

### BRIEF DESCRIPTION OF THE DRAWINGS

FIG. 1 is a block diagram showing the constitution of an MFP as an embodiment of the image forming apparatus of the present invention;

FIG. 2 is a block diagram showing a printer controller unit of the MFP shown in FIG. 1;

FIG. 3 is an example showing an object attribute expressed with PDL;

FIG. 4 is an image represented on the basis of the PDL shown in FIG. 3;

FIG. 5 is a flow chart showing the image forming method when obtaining print job data from outside the MFP shown in FIG. 1;

FIG. 6 is a flow chart showing the image processing method by the image processor unit of the printer controller shown in FIG. 2;

FIG. 7 is examples of images represented by the data of the gamma correction patterns described and stored in the PDLs;

FIG. 8 is examples of images of the gamma correction patterns composed in the page memory area;

FIG. 9 is a flow chart showing the pattern image forming method in the gamma correction table generation process;

FIG. 10 is a flow chart showing the pattern image reading method in the gamma correction table generation process; and

FIG. 11 is examples of images of the gamma correction patterns composed in the page memory area when there is no position detecting pattern available.

### DETAILED DESCRIPTION OF THE EMBODIMENTS

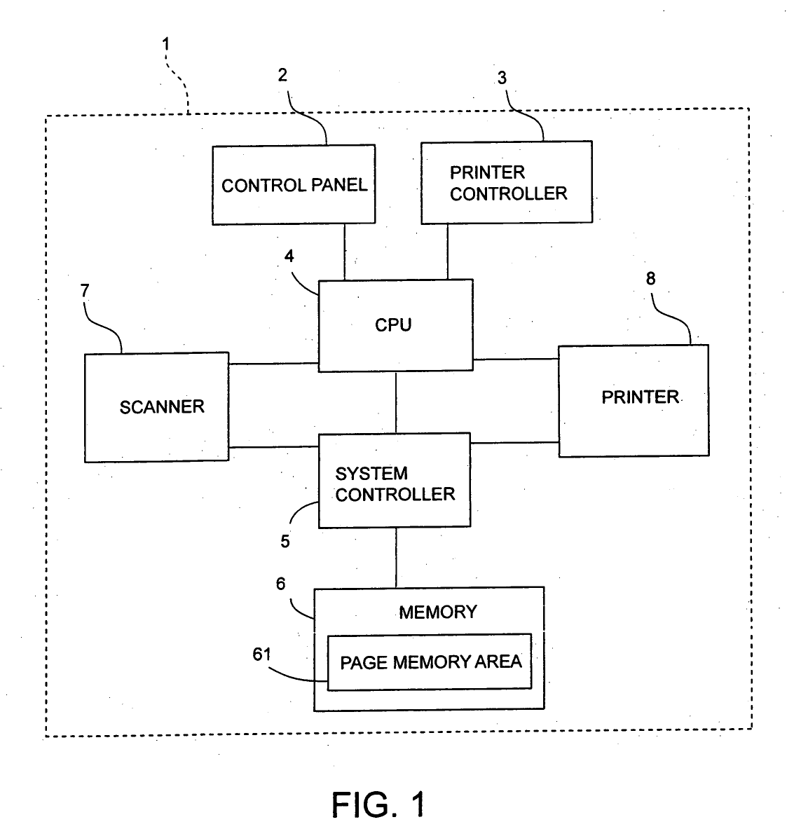

An embodiment of the present invention will be explained with reference to the accompanying drawings. FIG. 1 shows a block diagram of MFP 1 as an image forming apparatus relating to this embodiment. MFP 1 is composed of control panel 2, printer controller 3, CPU 4 (central processing unit), system controller 5, memory 6, scanner 7, and printer 8.

Control panel 2 has a keyboard for inputting the desired numbers of printing sheets and reading sheets, a display unit for displaying the number of inputted sheets and other set values, and a start button for starting printing.

Printer controller 3 communicates with the outside of MFP 1 such as serial connection, parallel connection, and network connection, for example, USB (universal serial bus) and RS-232C. Furthermore, printer controller 3, from external devices such as a personal computer and a server, receives print job data including a print control parameter including the number of print sheets and print image data on the basis of a predetermined protocol. Further, printer controller 3 interprets the received data and prepares raster image data composed of raster-converted print image data. Furthermore, printer controller 3 supplies the print control parameter to CPU 4.

CPU 4, on the basis of the print control parameter inputted from printer controller 3 and the set values stored in the memory, controls the operation of whole MFP 1. Further, CPU 4 controls output of the raster image data inputted from printer controller 3 to system controller 5.

System controller 5 controls sending and receiving image signals to and from memory 6, printer controller 3, and printer 8.

Memory 6 is a memory space composed of a RAM (random access memory), a ROM (read only memory), and HDD (hard disk drive). Memory 6 has page memory area 61 for storing raster image data of one page formed by printer 8. Memory 6 stores a set value inputted from printer controller 3 or a preset value. Raster image data stored in memory 6 may be enlarged, reduced, or rotated. To distinguish from raster image data inputted from printer controller 3, hereinafter, image data outputted from memory 6 is assumed as memory image data.

Scanner 7 reads a document and generates scanner image data.

Printer 8, on the basis of memory image data from system controller 5, forms images on sheets of paper.

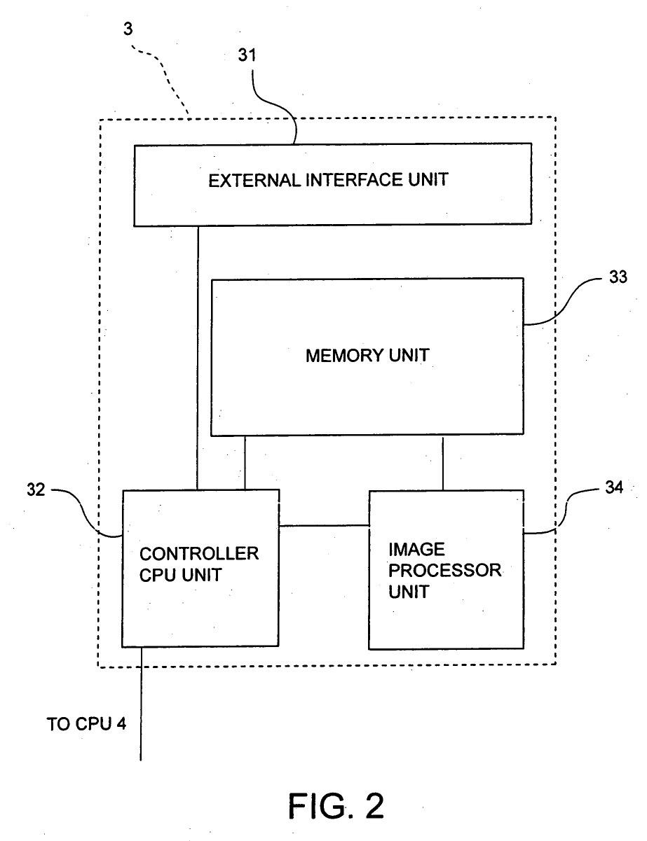

Printer controller 3, as shown in FIG. 2, has external interface unit 31, controller CPU unit 32, memory unit 33, and image processor unit 34.

External interface unit 31 communicates with outside MFP 1 such as serial connection, parallel connection, and network connection, for example, USB and RS-232C. Furthermore, external interface unit 31, from an external personal computer or server, receives print job data including the print control parameters and print image data on the basis of a predetermined protocol.

Controller CPU unit 32 controls external interface unit 31 and image processor unit 34. Further, controller CPU unit 32 controls input and output of image signals between image processor unit 34 and CPU 4. Further, controller CPU unit 32 interprets data received by external interface unit 31 and generates print control parameters and print image data. Further, control unit 32 is structured so as to be able to interpret a plurality of kinds of PDLs. Furthermore, controller CPU unit 32 monitors the gamma correction pattern output flags of the print control parameters, when an output instruction of gamma correction patterns is received, interprets the gamma correction patterns described and stored in the respective PDLs in memory unit 33 which will be described later, and generates print image data of the gamma correction patterns.

Memory unit 33 is composed of a RAM, a ROM, and a HDD. Print image data generated by controller CPU unit 32 and raster image data outputted by image processor unit 34 are stored in memory unit 33.

Further, the gamma correction pattern data corresponding to the respective PDLs is stored in memory unit 33 described in the respective PDLs. The data is described in the PDLs, so that the position information regarding where the respective gamma correction patterns are positioned is also stored. Although described in detail later, the gamma correction patterns stored in the respective PDLs are positioned so as not to be overlaid on each other. Further, the number Num[p] indicating up to what pattern number to be outputted on what the page P is stored in memory unit 33. Further, the gamma correction table what the gamma correction unit refers to is stored in memory unit 33. The process of generating a gamma correction table using the gamma correction patterns will be described later.

Image processor unit 34 executes color conversion, gamma correction, and half-tone processing for print image data outputted by controller CPU unit 32 and prepares raster image data which is raster-converted.

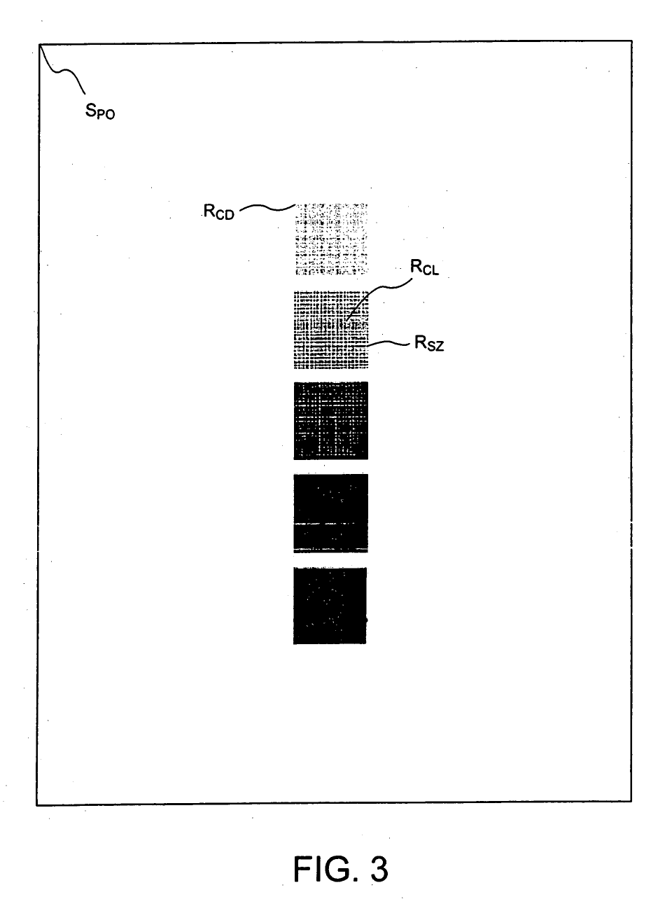

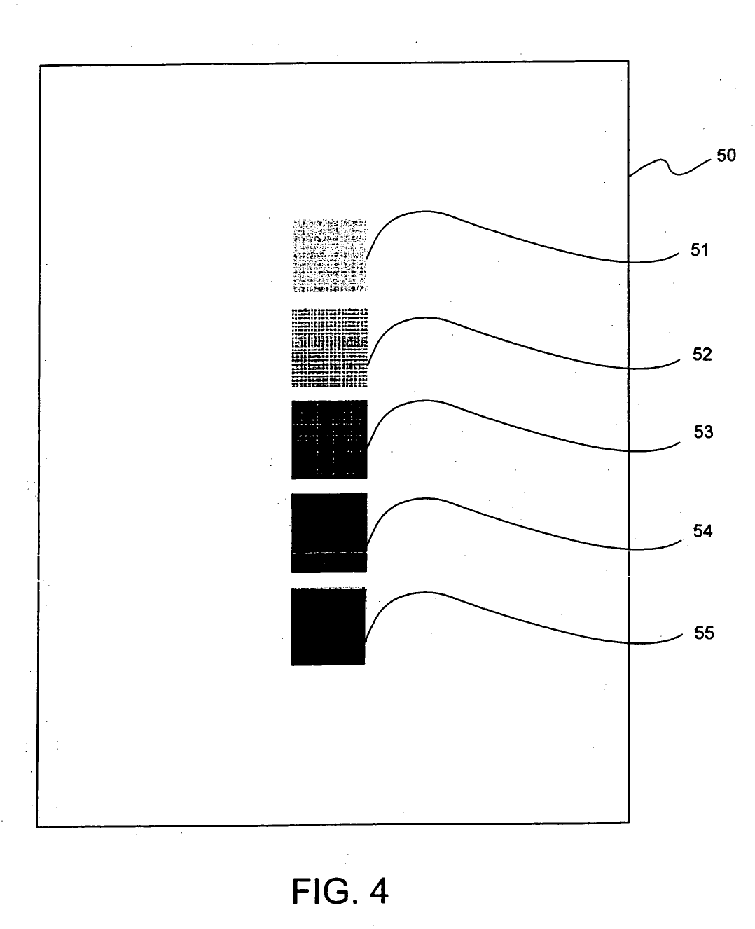

FIG. 3 shows an example of an object attribute expressed with PDL. In order to express a picture 50 comprising a plurality of rectangles 51 to 55 having different colors, respectively, shown in FIG. 4, information such as a starting point S_{PO} of the image, rectangular coordinates R_{CD}, rectangular sizes R_{SZ}, rectangular colors R_{CL}, etc. are described as PDL command.

As mentioned above, each PDL defines the position and represents an image. Inversely speaking, it is found in an image described in one PDL how any position of the image is drawn.

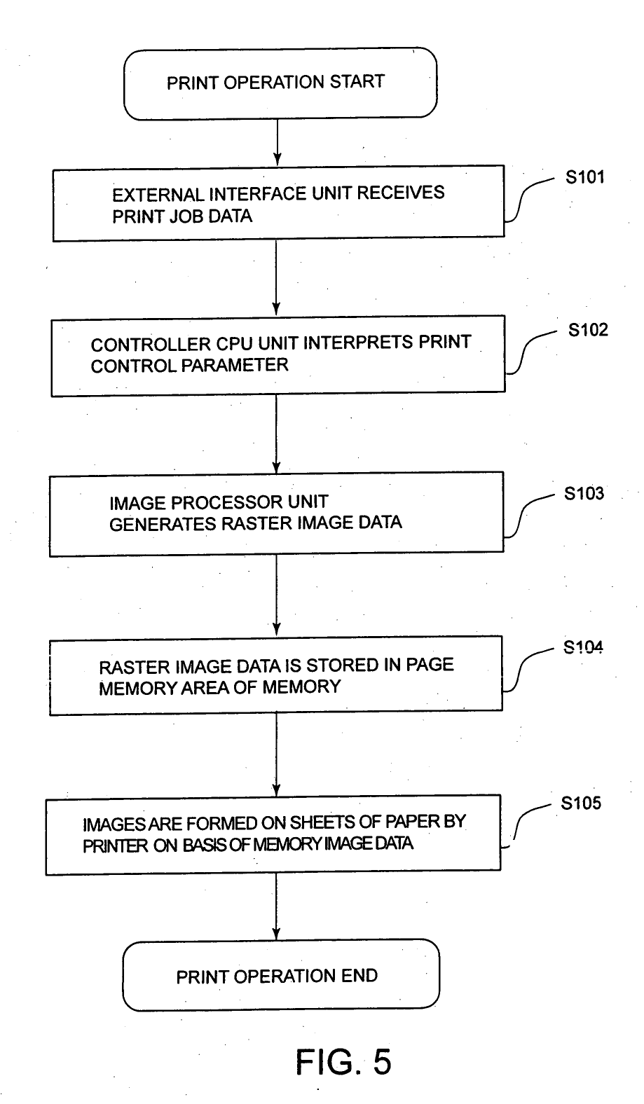

In MFP 1, the flow of image forming when obtaining print job data from outside MFP 1 will be explained by referring to FIG. 5.

Firstly, external interface unit 31 of printer controller 3, from an external personal computer or server, receives print job data including a print control parameter including the number of print sheets and print image data on the basis of a predetermined protocol (S101).

Controller CPU unit 32 interprets the print control parameter among the print job data received by external interface unit 31 (S102).

Further, image processor unit 34, by referring to the print control parameter interpreted by controller CPU unit 32, generates raster image data obtained by raster-converting the print image data described in a predetermined PDL (S103).

The raster image data generated by image processor unit 34 is sent to system controller 5 via controller CPU unit 32 and CPU 4 and is stored in page memory area 61 of memory 6. In memory 6, the process of rotating, enlarging, or reducing an image may be performed (S104).

Printer 8, on the basis of memory image data outputted from page memory area 61 of memory 6, forms an image on a sheet of paper (S105).

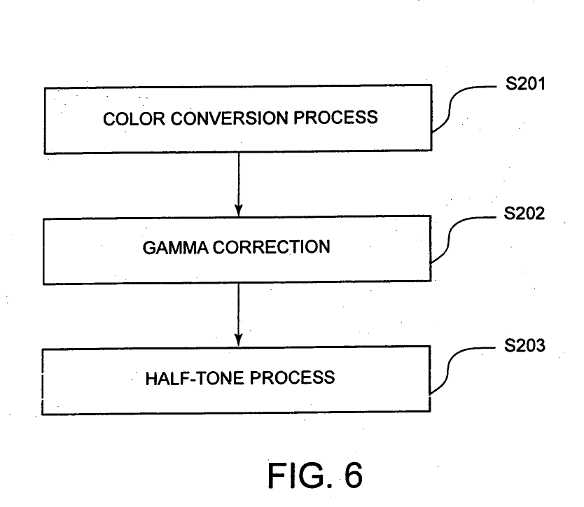

The flow of the image process by image processor unit 34 in the aforementioned image forming will be explained by referring to FIG. 6.

Firstly, image processor unit 34 refers to the color conversion table stored in memory unit 33 and for example, performs the color conversion process to print image data represented by the color space of R, G, and B on the input side. The print image data for which the color conversion process is performed is represented, for example, by the color space of Y, M, C, and K on the output side (S201).

In the color conversion process, depending on the constitution of MFP 1, color complementary operations simply from R, G, and B to Y, M, and C may be only executed. Further, instead of executing only simple conversion of the color space, a gamut conversion process may be executed. The color conversion process may be performed on the basis of a mathematical formula or may be performed by referring to the table.

Next, the gamma correction table stored in memory unit 33 is referred to and the print image data converted in color is subject to the gamma correction (S202).

Next, for the print image data subject to the gamma correction, the half-tone process is performed and the data is outputted as raster image data (S203).

As mentioned above, the image process is performed by image processor unit 34.

Next, the generation process of the gamma correction table will be explained.

The generation of the gamma correction table includes the steps of pattern image forming and pattern image reading.

Firstly, the gamma correction patterns described and stored in the PDLs in memory unit 33 will be explained.

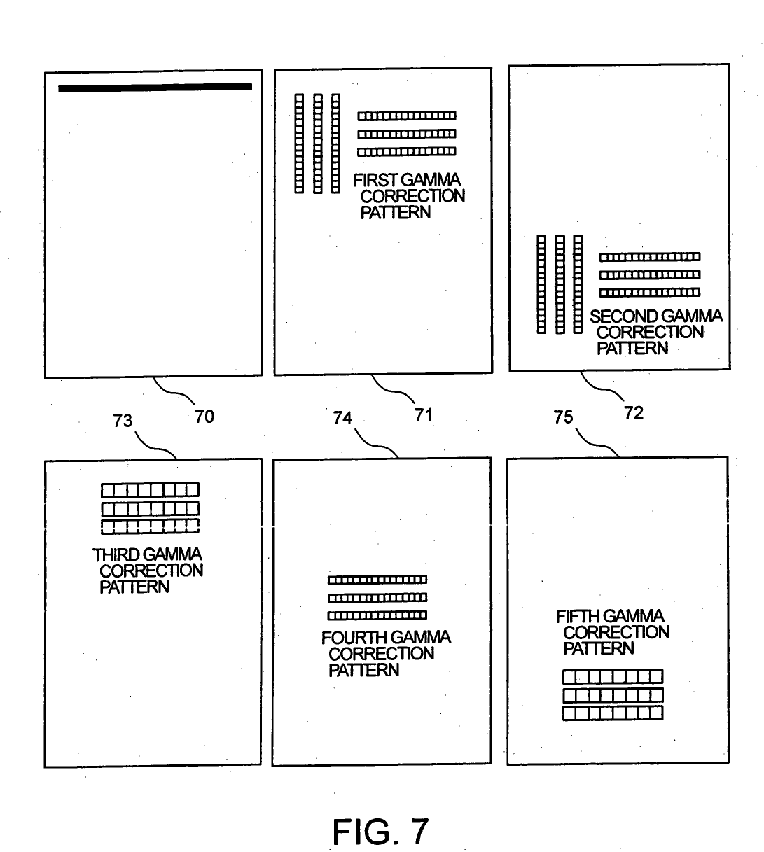

FIG. 7 shows examples of images represented by the data of the gamma correction patterns described in the PDLs and stored in memory 6 or memory unit 33. Here, one position detecting pattern is shown on one page. Further, five kinds of gamma correction patterns exist on each page one by one. Position detecting pattern 70 and each gamma correction pattern exist in positions where they are not overlaid on each other. Further, first gamma correction pattern 71 and second gamma correction pattern 72 exist in positions where they are not overlaid on each other. Further, third gamma correction pattern 73, fourth gamma correction pattern 74, and fifth gamma correction pattern 75 exist in positions where they are not overlaid on each other.

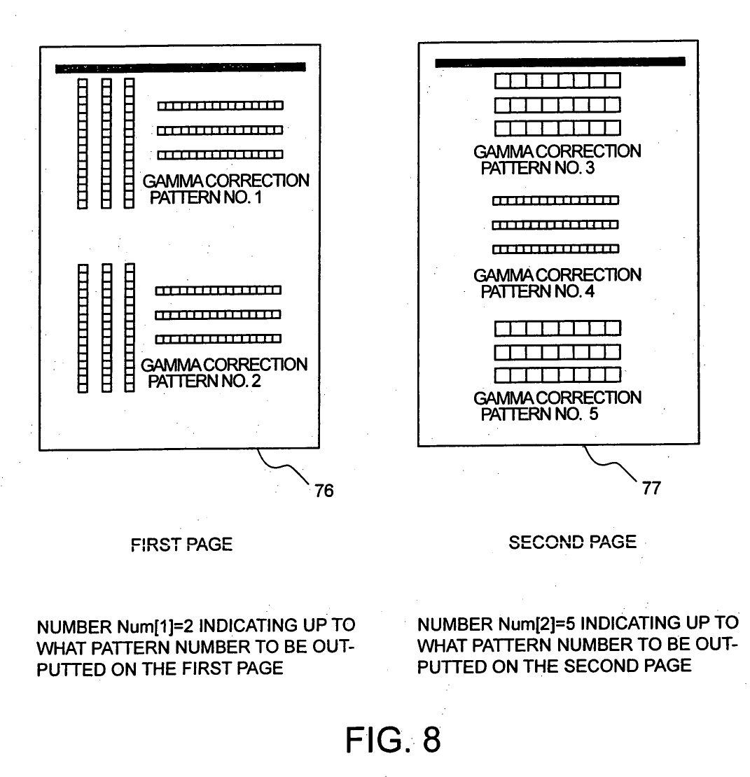

FIG. 8 shows images of the gamma correction patterns composed in page memory area 61 of memory 6. When the raster image data with position detecting pattern 70, first gamma correction pattern 71, and second gamma correction pattern 72 which exist in positions where they are not overlaid on each other are calculated a logical sum and are developed in the page memory area, image data as shown on first page 76 is generated. Further, when the raster image data with position detecting pattern 70, third gamma correction pattern 73, fourth gamma correction pattern 74, and fifth gamma correction pattern 75 which exist in positions where they are not overlaid on each other are calculated a logical sum and are developed in the page memory area, image data as shown on second page 77 is generated. Up to what pattern number to be outputted on the page P follows Num[p] stored in memory unit 33. Namely, here, on first page 76, the gamma correction patterns from first gamma correction pattern 71 to second gamma correction pattern 72 are formed, so that Num[1]=2. Further, on second page 77, the gamma correction patterns from third gamma correction pattern 73 to fifth gamma correction pattern 75 are formed, so that Num[2]=5.

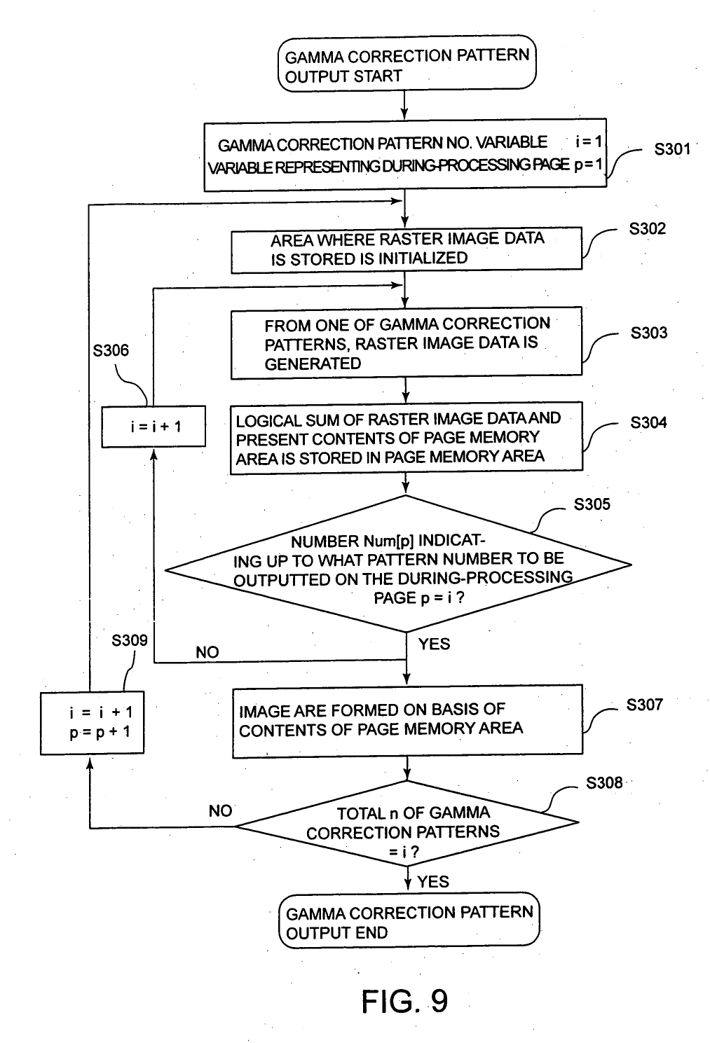

Next, the steps of forming pattern images, that is, forming gamma correction patterns described in the PDLs and stored in memory unit 33 on a series of paper will be explained by referring to FIG. 9.

When gamma correction pattern output job data is received from an external personal computer or server, pattern image forming is started. Output job data of gamma correction patterns is print job data in which a gamma correction pattern output flag of a print control parameter generated by interpreting the output job data is an output instruction of gamma correction patterns.

Controller CPU unit 32, when the gamma correction pattern output flag of the print control parameter of the print job data received by external interface unit 31 is an output instruction of gamma correction patterns, outputs the gamma correction patterns.

Or, when outputting of gamma correction patterns is instructed from control panel 2, the gamma correction patterns are outputted.

For gamma correction pattern output, firstly, the gamma correction pattern No. variable i and the variable p representing the during-processing page are initialized to 1 (S301).

Here, the gamma correction pattern No. variable i is a variable for storing the gamma correction pattern No. under processing at present.

Further, the variable p representing the during-processing page is a variable for storing the page No. under output processing at present.

Next, page memory area 61 of memory 6 is initialized (S302).

Next, from one of the gamma correction patterns described in the PDLs and stored in memory unit 33, raster image data is generated (S303).

Next, the raster image data and the present contents of page memory area 61 are calculated a logical sum and the result of the logical sum is stored in page memory area 61 (S304).

Next, the gamma correction pattern No. variable i is compared with the number Num[p] indicating up to what pattern number to be outputted on the page p under processing (S305).

When i is not Num[p], i is incremented by one and the process is returned to S303 (S306).

When i is Num[p], images are formed on the basis of the contents of page memory area 61 (S307).

Next, the gamma correction pattern No. variable i and the total n of gamma correction patterns are compared (S308).

When i is not n, i and p are respectively incremented by one and the process is returned to S302 (S309).

When i is n, the steps of pattern image forming is finished.

By these steps, the gamma correction patterns corresponding respectively to a plurality of PDLs can be composed in the page memory area. Further, the gamma correction patterns corresponding respectively to the plurality of PDLs can be formed on a series of paper at a time.

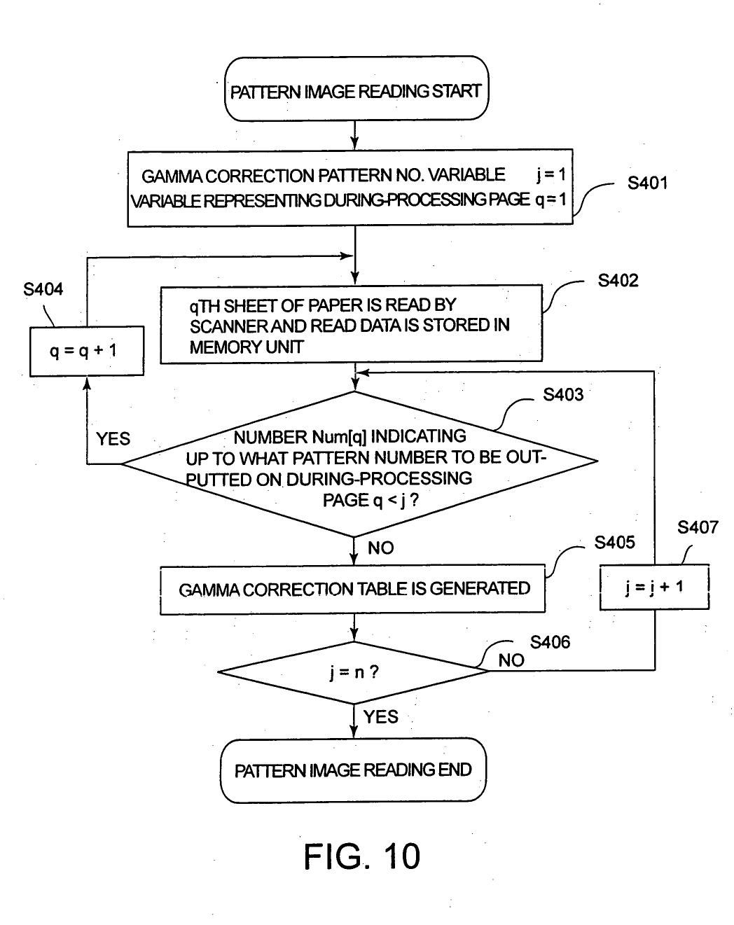

Next, the steps of reading pattern images for reading the gamma correction patterns formed on a series of paper at the steps of pattern image forming and of generating a gamma correction table will be explained by referring to FIG. 10.

When reading of the gamma correction patterns is instructed from control panel 2, the steps of reading pattern images are started.

Firstly, the gamma correction pattern No. variable j and the variable q representing the during-processing page are initialized to 1 (S401).

Next, the gamma correction pattern on the qth sheet of paper among the series of paper on which the gamma correction patterns are formed at the steps of pattern image forming is read by the scanner 7 and the scanner image data is stored in memory unit 33 (S402).

Next, the gamma correction pattern No. variable j is compared with the number Num[q] indicating up to what pattern number outputted on the page q under processing (S403).

When j is not larger than Num[q], the gamma correction pattern of j is included on the page q. Position detecting pattern 70 on the paper read by scanner 7 becomes a standard and the position where the gamma correction pattern of j on the scanner image data is to exist is found. On the basis of the found position and on the basis of the known art, a gamma correction table for the PDL corresponding to the concerned gamma correction pattern is generated (S405). The generated gamma correction table is stored in memory unit 33.

When j is larger than Num[q], the gamma correction pattern of j is not included before the page q, so that q is incremented by one and the process is returned to S402 (S404).

Next, the gamma correction pattern No. variable j and the total n of gamma correction patterns are compared (S406).

When j is not n, j is incremented by one and the process is returned to S403 (S407).

When j is n, the steps of pattern reading is finished.

By these steps, the series of paper on which the gamma correction patterns corresponding respectively to a plurality of PDLs are formed at a time is read and gamma correction tables corresponding respectively to the plurality of PDLs can be generated.

Further, in this embodiment, in page memory area 61 of memory 6 of MFP 1, gamma correction patterns are composed. However, gamma correction patterns may be composed in memory unit 33 of printer controller 3.

Further, the position detecting pattern is assumed as a standard and the position where each gamma correction pattern is to exist on the scanner image data is identified. However, from position information obtained from each PDL, the position where the gamma correction pattern is to exist may be identified. Hereinafter, this will be explained.

Firstly, the gamma correction patterns described in the PDLs and stored in memory unit 33 will be explained.

Position detecting pattern 70 shown in FIG. 7, since the position where the gamma correction pattern is to exist is identified from the position information obtained from the PDL, is not necessary.

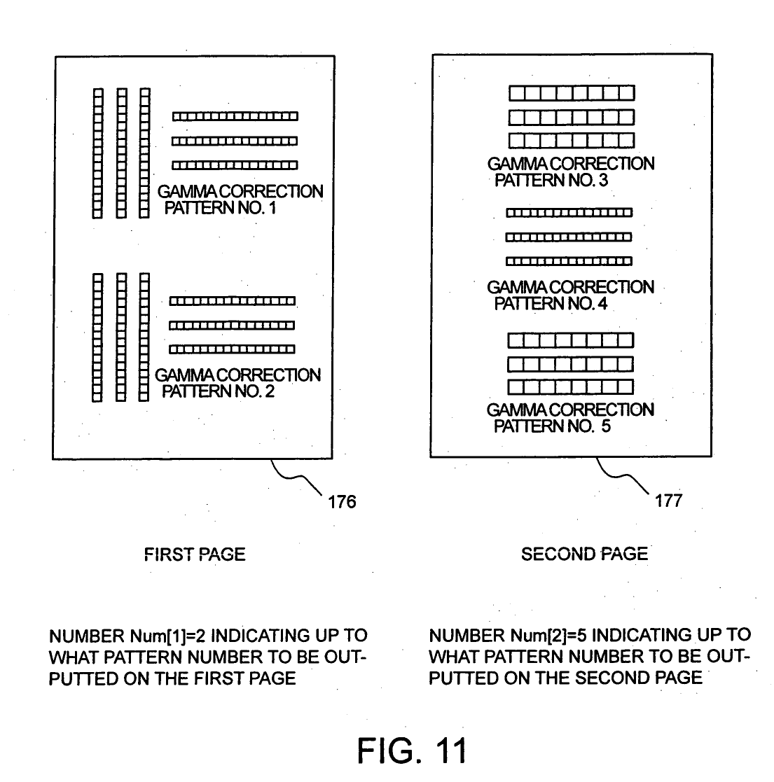

FIG. 11 shows examples of images of the gamma correction patterns composed in page memory area 61 of memory 6. Here, there is no position detecting pattern available and when raster image data with first gamma correction pattern 71 and second gamma correction pattern 72 existing in positions where they are not overlaid on each other are calculated a logical sum and are developed in the page memory area, image data as shown on the page 176 is generated. Further, when the raster image data with position detecting pattern 70, third gamma correction pattern 73, fourth gamma correction pattern 74, and fifth gamma correction pattern 75 which exist in positions where they are not overlaid on each other are calculated a logical sum and are developed in the page memory area, image data as shown on second page 77 is generated. Up to what pattern number to be outputted on the page P follows Num[p] stored in memory unit 33. Namely, here, on first page 76, the gamma correction patterns from first gamma correction pattern 71 to second gamma correction pattern 72 are formed, so that Num[1]=2. Further, on second page 77, the gamma correction patterns from third gamma correction pattern 73 to fifth gamma correction pattern 75 are formed, so that Num[2]=5.

The composed gamma correction patterns are formed on a sheet of paper. The gamma correction patterns are described in the PDLs, so that from the position information obtained from each PDL, the position on the paper where the gamma correction pattern is formed can be known.

When executing the steps of pattern image reading shown in FIG. 10 for the paper, at Step S405, from the position information obtained from the PDL, the position on the paper where the gamma correction pattern is formed is found. The position, where the gamma correction pattern of j on the scanner image data obtained by reading the paper on which the position where the gamma correction pattern is formed is known is to exist, is found. On the basis of the found position and on the basis of the known art, a gamma correction table for the PDL corresponding to the concerned gamma correction pattern is generated.

As mentioned above, on the basis of the position information of the gamma correction pattern obtained by interpreting the gamma correction pattern described in the PDL and scanner image data, a gamma correction table can be generated.

By the present invention, in a copier or an MFP having a plurality of PDLs or a printer controller connected to them, the gamma correction can be executed easily.

1. An image forming apparatus, comprising:
a controller capable of interpreting a plurality of PDLs (Page Description Language);
a memory unit to store a plurality of gamma correction patterns described in the plurality of PDLs which can be interpreted by the controller; and
a printer to form images on sheets of paper on the basis of raster image data of the gamma correction patterns outputted by the controller according to the gamma correction patterns stored in the memory unit,
wherein on the sheets of paper, a plurality of images are formed on the basis of the raster image data of the plurality of gamma correction patterns respectively corresponding to the plurality of PDLs.

2. The image forming apparatus according to claim 1, wherein the images outputted by the printer are formed on a series of paper.

3. The image forming apparatus according to claim 1 further comprising:
a page memory to store the raster image data of the gamma correction patterns outputted by the controller on the basis of the gamma correction patters stored in the memory unit,
wherein images are formed on the sheets of paper on the basis of the raster image data of the plurality of gamma correction patterns respectively corresponding to the plurality of PDLs composed on the page memory.

4. An image reading apparatus, comprising:
a controller capable of interpreting a plurality of PDLs;
a memory unit to store a plurality of gamma correction patterns described in the plurality of PDLs which can be interpreted by the controller; and
a scanner to read sheets of paper on which the plurality of gamma correction patterns are formed and output scanner image data,
wherein the controller generates a gamma correction table on the basis of position information of the gamma correction patterns obtained by interpreting the plurality of gamma correction patterns described in the plurality of PDLs and the scanner image data.

5. The image reading apparatus according to claim 4, wherein the scanner reads the series of paper and outputs the scanner image data.

6. The image reading apparatus according to claim 5 further comprising:
a printer to form images on sheets of paper on the basis of raster image data of the gamma correction patterns outputted by the controller according to the gamma correction patterns stored in the memory unit.

7. An image forming method, comprising:
interpreting a plurality of PDLs (Page Description Language) by a controller;
storing a plurality of gamma correction patterns described in the plurality of interpreted PDLs; and
forming images on sheets of paper on the basis of raster image data of the gamma correction patterns outputted by the controller according to the stored gamma correction patterns,
wherein a plurality of images are formed on the sheets of paper on the basis of the raster image data of the plurality of gamma correction patterns respectively corresponding to the plurality of PDLs.

8. The image forming method according to claim 7, wherein the images are formed on a series of paper.

9. The image forming method according to claim 7 further comprising:
storing the raster image data of the gamma correction patterns outputted by the controller on the basis of the stored gamma correction patters on a page memory,
wherein images are formed on the sheets of paper on the basis of the raster image data of the plurality of gamma correction patterns respectively corresponding to the plurality of PDLs composed on the page memory.

10. An image reading method, comprising:
interpreting a plurality of PDLs by a controller;
storing a plurality of gamma correction patterns described in the plurality of interpreted PDLs; and
reading sheets of paper on which the plurality of gamma correction patterns are formed and outputting scanner image data,
wherein the controller generates a gamma correction table on the basis of position information of the gamma correction patterns obtained by interpreting the plurality of gamma correction patterns described in the plurality of PDLs and the scanner image data.

11. The image reading method according to claim 10, wherein the image data is outputted by reading a series of paper.

12. The image forming method according to claim 10 further comprising:
forming images on sheets of paper on the basis of raster image data of the gamma correction patterns outputted by the controller according to the stored gamma correction patterns.
